(19) United States
(12) Patent Application Publication
(10) Pub. No.: US 2024/0371564 A1
(43) Pub. Date: Nov. 7, 2024

(54) SECONDARY COIL ASSEMBLY FOR AN INDUCTIVE ENCODER SYSTEM, AND INDUCTIVE ENCODER SYSTEM

(71) Applicant: NEURA ROBOTICS GMBH, Metzingen (DE)

(72) Inventor: Josef SIRAKY, Donaueschingen (DE)

(21) Appl. No.: 18/683,020

(22) PCT Filed: Jun. 24, 2022
(86) PCT No.: PCT/EP2022/067425

§ 371 Date: Apr. 23, 2024

(30) Foreign Application Priority Data
Aug. 12, 2021 (DE) 10 2021 121 052.6

(51) Int. Cl. H01F 27/28; G01D 5/20

(52) U.S. Cl. CPC H01F 27/28; G01D 5/204

(57) ABSTRACT

Secondary coil assembly (15) for an inductive encoder system (10) comprising a plurality of secondary coils (16, 16a, 18, 18a, 20, 20a, 22, 22a), wherein each secondary coil (16, 16a, 18, 18a, 20, 20a, 22, 22a) has a secondary coil conductor track (23), wherein the secondary coil conductor tracks (23) are arranged on a conductor support such that they do not cross; and an inductive encoder system (10) comprising at least one primary coil (12, 12a, 12b), which has a modulation region (14), and at least one receiver track (42), which has at least one receiver line set (44a, 44b, 44c, 44d) and an aforementioned secondary coil assembly (15), the secondary coil assembly (15) being arranged within the modulation region (14).

The invention relates to a secondary coil assembly for an inductive encoder system and an inductive encoder system.

Due to their robustness against environmental influences, inductive encoder systems are used in a wide variety of application areas. They can in particular be designed as rotary encoders or length measuring systems.

Basically, inductive encoder systems are constructed in such a way that a primary coil generates a magnetic field, which induces a current in one or more secondary coils. In the presence of an electrically conductive target, the voltage induced in the secondary coils changes, allowing the position of the target relative to the secondary coils to be determined.

The construction of inductive encoder systems is preferably achieved with printed circuit boards, with the coils being attached to the printed circuit boards using conductor tracks. In order to obtain the sinusoidal signals preferably used for path or angle measurement the coil geometries, in particular of the secondary coils, must be designed accordingly. For example, DE 103 20 990 A1 discloses an inductive rotary encoder in which the coil geometries of the secondary coils are sinusoidal and cosinusoidal. Due to the resulting sinusoidal and cosinusoidal shape of the measurement signals taken from the secondary coils, a linear position value of the target can be calculated over a period using an arc tangent function.

The disadvantage of the prior art is that the conductor tracks, in particular the secondary coil conductor tracks, cross each other in the modulation region that is important for signal generation, and it is therefore necessary to use plated through-holes. Connections in conductor supports that establish electrical contact between conductor tracks arranged on different conductor support levels are usually referred to as plated through-holes. If two conductor tracks cross each other, one of the conductor tracks in the crossing area is usually moved to a different conductor support level so that, despite the crossing, no electrically conductive contact is created between the relevant conductor tracks. As a rule, two plated through-holes are arranged at each intersection.

A through-hole connection usually requires a circular area with a diameter of approx. 0.3 mm. In addition, a distance of at least 0.1 mm must be maintained from passing conductor tracks. A high-resolution encoder system and the required implementation of very small periods cannot therefore be realized.

In addition, the large number of plated through-holes required eliminates manufacturing technologies that would allow a smaller period length, but with which plated through-holes are difficult to implement. Producing these encoder systems using such manufacturing technologies is not economically viable. An example is the sputtering of conductor tracks on glass or plastic with a conductor track thickness of a few micrometers. In principle, period lengths within the range of 100 μm could be achieved.

In addition, the plated through-holes arranged in the modulation region result in harmonics in the measurement signals taken from the secondary coils. This negatively affects the quality of the measurement signals, particularly with regard to the linearity of the arc tangent calculated from the sine and cosine signals, and thus the accuracy of the measurement results.

The invention is therefore based on the object of providing a secondary coil assembly for an inductive encoder system, with which a high resolution can be achieved, which can be produced flexibly and with which the quality of the measurement result is improved. A further object of the invention is to provide a corresponding inductive encoder system.

The object is achieved according to the invention by a secondary coil assembly for an inductive encoder system with the features of claim 1 and an inductive encoder system with the features of claim 7.

Advantageous embodiments and developments of the invention are specified in the dependent claims.

A secondary coil assembly according to the invention for an inductive encoder system has a plurality of secondary coils, each secondary coil having a secondary coil conductor track, and the secondary coil conductor tracks being arranged on a conductor support such that they do not cross. The conductor tracks from which the secondary coils are formed are preferably referred to as secondary coil conductor tracks. Connection conductor tracks with which the secondary coil conductor tracks are brought into contact, for example for integration into a circuit, are preferably not viewed as part of the secondary coil conductor tracks. The secondary coils are preferably arranged in such a way that the secondary coil conductor tracks do not cross each other in a top view in the direction of a secondary coil axis. Because the secondary coil conductor tracks are arranged such that they do not cross, a secondary coil assembly can be provided, whose secondary coil conductor tracks have no plated through-holes. This means that the manufacturing effort in particular can be reduced. In addition, the distances between the individual conductor tracks can be reduced, which means that the resolution of an encoder system comprising the secondary coil assembly can be increased. In addition, the quality of the measurement signals taken from the secondary coils can be improved. The conductor support can be formed, for example, by a circuit board or glass plate. Particularly if the conductor support is formed by a glass plate, the conductor tracks can be sputtered on.

Each secondary coil preferably has a secondary coil surface with a secondary coil contour, the secondary coil contour corresponding to the contour which has an area which is included in the interval of 45° to 225° between a sine function and a cosine function. This allows secondary coil contours with a typical curved shape to be realized. In the following, this form will be referred to as the sine-cosine difference form. In particular, the characteristics of a conventional secondary coil assembly can be reproduced well with such secondary coils.

Particularly preferably, the secondary coil assembly has an assembly contour which corresponds at least in sections to the contour which has a surface which is formed by a plurality of sine-cosine difference surfaces arranged adjacent to one another. The assembly contour is preferably the outline of the area covered by the entire secondary coil assembly. With such an assembly, measurement signals with a sinusoidal or cosinusoidal curve can be generated using the secondary coil assembly.

In a preferred embodiment of the invention, the secondary coil assembly is arranged linearly, circularly, or in the shape of an annulus. With a linear assembly, a length measuring system in particular can be implemented. A circular or annular assembly of the secondary coil assembly is preferably used for rotary encoders, i.e. in particular for angle measuring systems. In the case of a circular or annular assembly of the secondary coil assembly, the circular shape is preferably superimposed on the secondary coil contour or the assembly contour. This can result in a typical flower-shaped assembly contour.

Preferably, the secondary coils are arranged adjacent to one another in a longitudinal direction of the secondary coil assembly. The adjacent assembly is preferably implemented in such a way that two adjacent secondary coils are electrically insulated from one another. The longitudinal direction is preferably formed by the direction in which a target whose position is to be determined is intended to move relative to the secondary coil assembly. In particular, in the case of a circular or annular secondary coil assembly, the longitudinal direction can be correspondingly arcuate in the direction of a corresponding circular arc.

If the secondary coils are designed in sine-cosine difference form, the secondary coils are preferably arranged adjacent to one another in such a way that a phase shift of 90° results between the individual secondary coils. A secondary coil assembly can therefore have a, in particular, repeating secondary coil set of, in particular, four secondary coils. If a first secondary coil is referred to as a positive sine coil according to a contour line delimiting it at the top, a second secondary coil adjacent to it on the right can be referred to as a positive cosine coil. This can be followed by a negative sine coil as the third secondary coil and a negative cosine coil as the fourth secondary coil. The negative cosine coil is preferably followed by a positive sine coil of another secondary coil set.

In a further development of the invention, the secondary coils are arranged in several blocks arranged parallel to one another in the longitudinal direction. In particular, the secondary coils can thereby be arranged offset from one another in the longitudinal direction. This allows the number of secondary coils per unit length to be increased in the longitudinal direction. This allows the accuracy of an encoder system that accommodates the secondary coil assembly to be increased.

The conductor support preferably has at least one conductor support level and the adjacent secondary coils can be arranged in the same conductor support level or in different conductor support levels. By arranging the secondary coils in the same conductor support level, the complexity of the conductor support and thus in particular the manufacturing effort can be reduced. By arranging the secondary coils on different conductor support levels, the adjacent secondary coils can be arranged without any offset in the longitudinal direction, without an electrically conductive contact being created between the adjacent secondary coils.

An inductive encoder system according to the invention comprises at least one primary coil, which has a modulation range, and at least one receiver track, which has at least one receiver line set and a secondary coil assembly described above, the secondary coil assembly being arranged within the modulation range. The area surrounded by the at least one primary coil is preferably referred to as the modulation region. Preferably, a primary coil current flows in the at least one primary coil, which is particularly preferably designed as an alternating current. As a result, a voltage can be induced in particular in the secondary coils arranged in the modulation region. As a result, the induction of the voltage in this at least one secondary coil can be influenced by arranging an electrically conductive target over at least one of the secondary coils.

The encoder system can have at least one secondary coil set made up of a plurality of secondary coils, wherein the secondary coils of the at least one secondary coil set can be brought into contact differently to the at least one receiver line set. The secondary coils can be brought into contact with the at least one receiver line set using connecting conductor tracks. A receiver circuit is preferably formed by a receiver line set, the secondary coils in contact therewith and, if necessary, the connecting conductor tracks used for the respective contacting. Particularly preferably, the secondary coils in contact with the same receiver line set have different flow directions. This allows the position of the target to be absolutely determined in the region of the at least one secondary coil set. Preferably, the different flow directions are realized in that the secondary coils in contact with the same receiver line set are polarized differently.

In a preferred embodiment of the invention, the at least one receiver track has a first receiver line set and a second receiver line set, and the at least one secondary coil set has a first secondary coil, a second secondary coil, a third secondary coil, and a fourth secondary coil, the first secondary coil and the third secondary coil being in contact with the first receiver line set and the second secondary coil and the fourth secondary coil being in contact with the second receiver line set. The first to fourth secondary coils are particularly preferably arranged adjacent to one another in ascending order.

In particular if no target is arranged above the secondary coil assembly, the voltages induced in the first secondary coil and the voltages induced in the third secondary coil can be at least approximately the same in magnitude. The same preferably applies to the voltages induced in the second secondary coil and the fourth secondary coil. Due to the different flow direction of the secondary coils in contact with the same receiver line set, at least approximately no current flows in the respective receiver circuit, as long as there is no target above the secondary coil assembly. If the target is at least partially arranged above one of the secondary coils, the voltage induced in this secondary coil can change in comparison to the other secondary coil arranged in the same receiver circuit so that a current can flow in the corresponding receiver circuit. The target is preferably designed in such a way that it can completely cover at most one of the secondary coils. Because the secondary coils that are not directly adjacent to one another are each arranged in the same receiver circuit, the resolution of the encoder system can be improved.

If the encoder system has a plurality of successive secondary coil assemblies, the target is preferably designed in such a way that it has a plurality of target elements. The target elements are preferably arranged at such a distance from one another that the corresponding secondary coils of two successive secondary coil assemblies can be covered. The target can therefore be designed as a grid. This allows the target to be arranged over the corresponding secondary coils at the same time.

In a further development of the invention, the encoder system has at least one receiver track, a third receiver line set, and a fourth receiver line set. In addition, the at least one secondary coil set can have a fifth secondary coil, a sixth secondary coil, a seventh secondary coil, and an eighth secondary coil, the fifth secondary coil and the seventh secondary coil being in contact with the third receiver line set and the sixth secondary coil and the eighth secondary coil being in contact with the fourth receiver line set. As a result, the region of a secondary coil set and thus preferably the area in which the position of a target can be determined absolutely can be made particularly large and/or have a particularly high concentration of secondary coils, as a result of which the resolution of the encoder system can be increased.

The invention can be designed such that the first receiver line set and the third receiver line set are in electrically conductive contact with one another, and that the second receiver line set and the fourth receiver line set are in electrically conductive contact with one another. As a result, when using the encoder system, it may be sufficient to connect two of the receiver line sets to an evaluation unit. Preferably, the first receiver line set and the third receiver line set and the second receiver line set and the fourth receiver line set are in contact with one another in such a way that the adjacent secondary coils have different flow directions.

Preferably, the secondary coils in contact with the same receiver line set are arranged offset in the longitudinal direction in different blocks. This allows the resolution of the encoder system to be increased, particularly with the same coil dimensions. The offset is preferably between half and twice the dimension of a secondary coil in the longitudinal direction.

In a further development of the invention, the inductive encoder system has a first receiver track and a second receiver track, the first receiver track having a plurality of secondary coil sets and the second receiver track having exactly one secondary coil set. The first receiver track and the second receiver track are preferably arranged next to one another in the longitudinal direction. Using the first receiver track, the position of the target can be determined with a relatively high level of accuracy. Using the second receiver track, the position of the target can be determined absolutely over the entire length of the encoder system. This allows the position of the target to be absolutely determined over the entire length of the encoder system with a relatively high level of accuracy.

Particularly preferably, the at least one primary coil is arranged on a first conductor support level and the secondary coil assembly is arranged on a second conductor support level. In addition, the at least one receiver line set can be arranged on the second conductor support level. In particular, if the at least one receiver line set is arranged outside the modulation range, the secondary coils can thereby be in contact with the at least one receiver line set without plated through-holes being required.

The at least one primary coil of the inductive encoder system can be annular. As a result, the modulation region can be circular. Preferably, the at least one primary coil is annular if the secondary coil assembly is arranged in a circle or annularly. The at least one primary coil is preferably annular if the inductive encoder system is designed as a rotary encoder.

In a further development of the invention, the modulation region is annular with an outer diameter and an inner diameter and is delimited on the outer diameter by a first primary coil and on the inner diameter by a second primary coil. As a result, the electromagnetic field in the modulation region can be made more concentrated and homogeneous, which in particular can increase the quality of the measurement signals to be picked up at the receiver coils. Such a design of the inductive encoder system can be particularly advantageous in the case of large diameters of the primary coils and the secondary coil assembly.

The concentration and homogeneity of the electromagnetic field in the modulation region can be further increased by making a current direction in the first primary coil opposite to the current direction in the second primary coil.

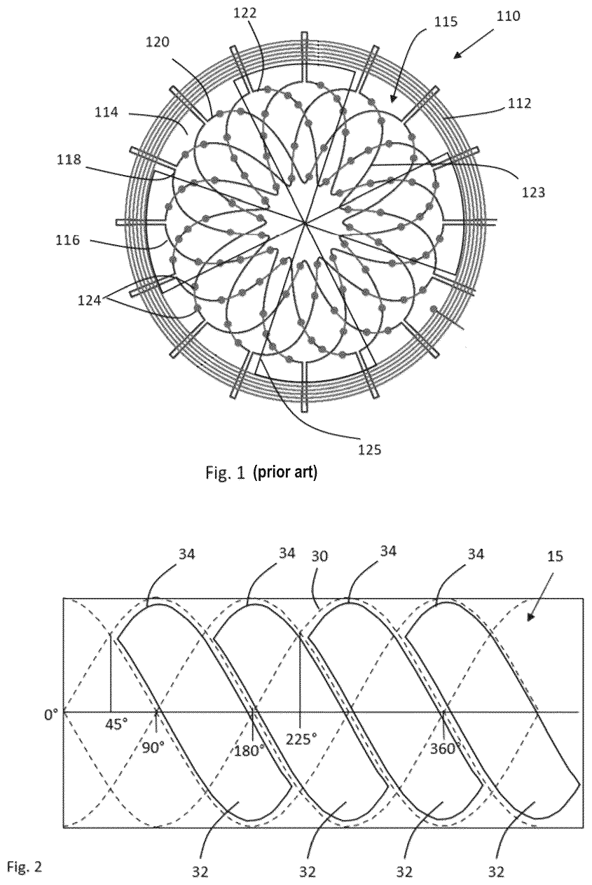

An exemplary embodiment of an inductive encoder system from the prior art is shown in FIG. 1.

Exemplary embodiments of the invention are explained using the figures mentioned below. In the drawings:

FIG. 2 is a schematic representation of a secondary coil assembly with a sine-cosine difference form;

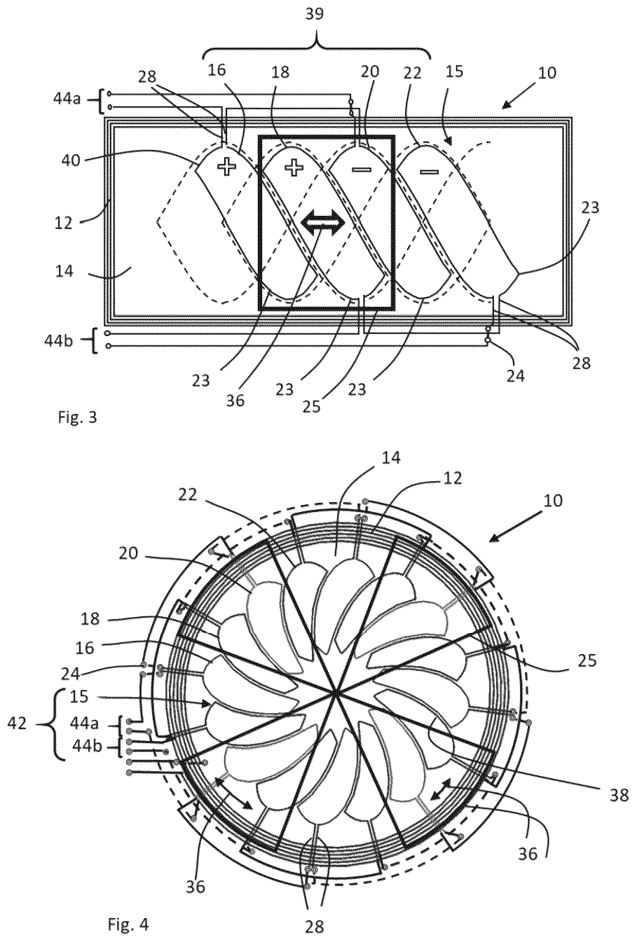

FIG. 3 is a schematic representation of a first exemplary embodiment of an inductive encoder system with a linear secondary coil assembly;

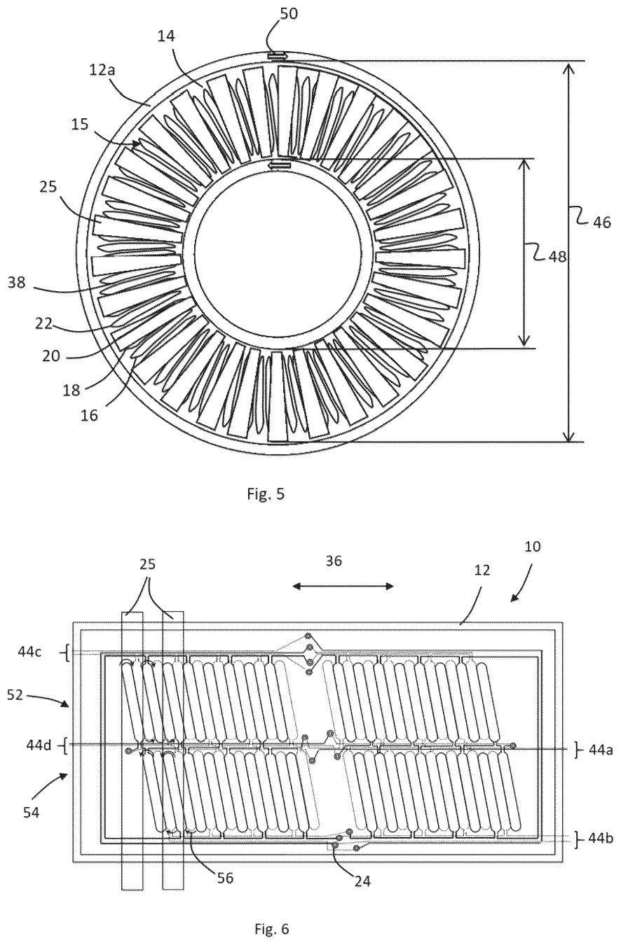

FIG. 4 is a schematic representation of a second exemplary embodiment of an inductive encoder system with an annular secondary coil assembly;

FIG. 5 is a schematic representation of a part of a third exemplary embodiment of an inductive encoder system with an annular secondary coil assembly and an annular modulation region;

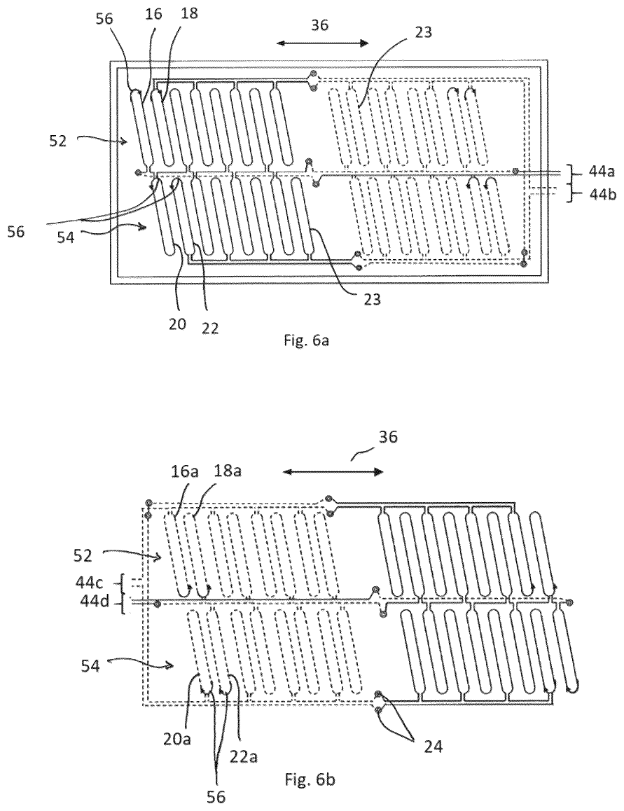

FIG. 6 is a schematic representation of a fourth exemplary embodiment of an inductive encoder system;

FIG. 6a is a schematic representation of a first part of the exemplary embodiment shown in FIG. 6; and

FIG. 6b is a schematic representation of a second part of the exemplary embodiment shown in FIG. 6.

FIGS. 1 to 6b show various exemplary embodiments. For the sake of clarity, not all reference numbers are used in every figure. The same reference numbers are used for identical and functionally identical parts.

FIG. 1 shows an inductive encoder system 110 from the prior art with an annular primary coil 112 which has a circular modulation region 114. In the modulation region 114, a secondary coil assembly 115 having a first secondary coil 116, a second secondary coil 118, a third secondary coil 120, and a fourth secondary coil 122 is arranged in a circular ring. Each of the secondary coils 116, 118, 120, 122 has a secondary coil conductor track 123. The conductor tracks from which the secondary coils 116, 118, 120, 122 are formed are preferably referred to as secondary coil conductor tracks 123. The secondary coils 116, 118, 120, 122 are arranged in the same conductor support level. A through contact 124, shown as a point in each case, is arranged before and after each intersection. A four-part target 125 is shown above the secondary coil assembly 115.

A secondary coil assembly 15 according to the invention for an inductive encoder system 10 has a plurality of secondary coils 16, 18, 20, 22, each secondary coil 16, 18, 20, 22 comprising a secondary coil conductor track and the secondary coil conductor tracks 23 are arranged on a conductor support such that they do not cross. Exemplary embodiments of such encoder systems are shown in FIGS. 3, 5 and 6. Because the secondary coil conductor tracks 23 are arranged such that they do not cross, a secondary coil assembly 15 can be provided whose secondary coil conductor tracks 23 do not have any plated through-holes 24. Connection conductor tracks 28 (see FIGS. 3 and 4), with which the secondary coil conductor tracks 23 are in contact, for example for integration into a circuit, are preferably not viewed as part of the secondary coil conductor tracks 23.

Particularly preferably, each secondary coil 16, 18, 20, 22 has a secondary coil surface 32 with a secondary coil contour 34, wherein the secondary coil contour 34 corresponds to the contour which has an area which is included in the interval of 45° to 225° between a sine function and a cosine function. This allows secondary coil contours 34 to be realized which have the sine-cosine difference form. In addition to the secondary coil assembly 15 shown in FIG. 2, the exemplary embodiments shown in FIGS. 3, 4, and 5 have secondary coil contours 34 in a sine-cosine difference form.

As shown schematically in FIG. 2, the secondary coil assembly 15 preferably has an assembly contour 30 which corresponds at least in sections to the contour which has a surface which is formed by a plurality of sine-cosine difference surfaces arranged adjacent to one another. The assembly contour 30 is preferably the outline of the area covered by the entire secondary coil assembly 15.

In the exemplary embodiment shown in FIG. 3, the secondary coil assembly 15 is arranged linearly. With a linear assembly, a length measuring system in particular can be implemented. In the exemplary embodiments shown in FIGS. 4 and 5, the secondary coil assemblies 15 are arranged annularly. The circular shape is preferably superimposed on the secondary coil contour 15 or the assembly contour 30. This can result in a typical flower-shaped assembly contour 30, as shown in FIGS. 4 and 5. An annular assembly of the secondary coil assembly 15 is preferably used for rotary encoders, i.e. in particular for angle measuring systems.

The secondary coils 16, 18, 20, 22 are preferably arranged adjacent to one another in a longitudinal direction 36 of the secondary coil assembly 15. The adjacent assembly is preferably implemented in such a way that two adjacent secondary coils 16, 18, 20, 22 are electrically insulated from one another. As shown in particular in FIGS. 4 and 5, an insulating gap 38 can be arranged between two adjacent secondary coils 16, 18, 20, 22. The longitudinal direction 36 is preferably formed by the direction in which a target 25 whose position is to be determined is intended to move relative to the secondary coil assembly 15. In particular, in the case of an annular secondary coil assembly 15, the longitudinal direction 36 can be correspondingly arcuate in the direction of a corresponding circular arc.

If the secondary coils 16, 18, 20, 22 are designed in sine-cosine difference

form, the secondary coils 16, 18, 20, 22 are preferably arranged adjacent to one another in such a way that there is a phase shift of 90° between the individual secondary coils 16, 18, 20, 22. If the first secondary coil 16 is referred to as a positive sine coil according to a contour line 40 delimiting it at the top, a second secondary coil 18 adjacent to it on the right can be referred to as a positive cosine coil. This can be followed by a negative sine coil as the third secondary coil 20 and a negative cosine coil as the fourth secondary coil 22. The four secondary coils 16, 18, 20, 22 can thus form a secondary coil set 39. In a secondary coil assembly 15, a plurality of secondary coil sets can be arranged one behind the other (see FIGS. 4 and 5). The fourth secondary coil 22, designed as a negative cosine coil, is then preferably followed by a first secondary coil 16, designed as a positive sine coil, of a further secondary coil set 39.

An inductive encoder system 10, as shown in FIGS. 3 and 4, comprises a primary coil 12, which comprises the modulation range 14, as well as the receiver track 42, the receiver line sets 44a, 44b, and a secondary coil assembly 15 described above, wherein the secondary coil assembly 15 is arranged within the modulation range. The area surrounded by the primary coil 12 is preferably referred to as the modulation region 14. Preferably, a primary coil current flows in the primary coil 12, which is particularly preferably designed as an alternating current. As a result, a voltage can be induced in particular in the secondary coils 16, 18, 20, 22 arranged in the modulation region 14. As a result, the induction of the voltage in this at least one secondary coil 16, 18, 20, 22 can be influenced by arranging the electrically conductive target 25 over at least one of the secondary coils 16, 18, 20, 22. In the view shown in FIG. 3, for example, the target 25 is arranged completely above the second secondary coil 18 and partially above the first secondary coil 16 and the third secondary coil 20.

The secondary coils 16, 18, 20, 22 of a secondary coil set 39 can be brought into contact differently with the receiver line sets 44a, 44b. Particularly preferably, two secondary coils 16, 18, 20, 22, which are in contact with the same receiver line set 44a, 44b, are polarized differently. By making different contacts, the position of the target 25 can be absolutely determined in the region of a secondary coil set 39.

In the exemplary embodiments shown in FIGS. 3 and 4, the receiver track 42 preferably has a first receiver line set 44a and a second receiver line set 44b, and each of the secondary coil sets has the first secondary coil 16, the second secondary coil 18, the third secondary coil 20, and the fourth secondary coil 22, wherein the first secondary coil 16 and the third secondary coil 20 are each in contact with the first receiver line set 44a and the second secondary coil 18 and the fourth secondary coil 22 are each in contact with the second receiver line set 44b.

The contacting is preferably carried out using the connecting conductor tracks 28. The first secondary coil 16 and the third secondary coil 20 can, with the connecting conductor tracks 28 arranged thereon and the first receiver line set 44a, form a first receiver circuit. Accordingly, the second secondary coil 18 and the fourth secondary coil 22 can, with the connecting conductor tracks 28 arranged thereon and the first receiver line set 44a, form a second receiver circuit. The first secondary coil 16 and the third secondary coil 20 are each polarized differently and the second secondary coil 18 and the fourth secondary coil 22 are each polarized differently. The first to fourth secondary coils 16, 18, 20, 22 are preferably arranged adjacent to one another in ascending order.

In particular, if no target 25 is arranged above the secondary coil assembly 15, the voltages induced in the first secondary coil 16 and the voltages induced in the third secondary coil 20 can be at least approximately the same in magnitude (see in particular FIG. 3). The same preferably applies to the voltages induced in the second secondary coil 18 and the fourth secondary coil 22. Due to the different polarities of the secondary coils 16, 18, 20, 22 arranged on the same receiver line set 44a, 44b, at least approximately no current flows in the respective receiver circuit, as long as there is no target 25 above the secondary coil assembly 15. If the target 25 is at least partially arranged above one of the secondary coils 16, 18, 20, 22, the voltage induced in this secondary coil can change in comparison to the other secondary coils 16, 18, 20, 22 arranged on the same receiver line set 44a, 44b so that a current can flow in the corresponding receiver circuit. The target 25 is preferably designed so that it can completely cover at most one of the secondary coils 16, 18, 20, 22.

As shown in FIGS. 3 and 4, there are preferably no plated through-holes 24, the secondary coil assembly 15 or the receiver line sets 44a, 44b arranged within the modulation region 14. Particularly preferably, the primary coil 12 is arranged on a first conductor support level and the secondary coil assembly 15 on a second conductor support level. As a result, as shown in FIGS. 3 and 4, no plated through-holes 24 are required when the primary coil 12 and the connecting conductor tracks 28 cross. The receiver line sets 44a, 44b can also be arranged on the second conductor support level. In particular, if the receiver line sets 44a, 44b are arranged outside the modulation region 14, the secondary coils 16, 18, 20, 22 can thereby be brought into contact with the receiver line sets 44a, 44b without plated through-holes 24 being required.

The primary coil 12 of the encoder system 10 can be annular, as shown in FIG. 4. As a result, the modulation region 14 can be circular. In the exemplary embodiment shown in FIG. 5, the modulation region 14 is annular with an outer diameter 46 and an inner diameter 48 and is delimited on the outer diameter 46 by a first primary coil 12a and on the inner diameter 48 by a second primary coil 12b. Preferably, a current direction 50 in the first primary coil 12a is designed to be opposite to the current direction 50 in the second primary coil 12b.

In comparison to the exemplary embodiment shown in FIG. 4, which preferably has four sets of secondary coils 39, the exemplary embodiment shown in FIG. 5 can have 32 sets of secondary coils 39. Accordingly, the encoder system shown in FIG. 5 can have a 32-part target 25. By means of the high number of secondary coil sets 39, the resolution of the encoder system 10 can be significantly increased. Such a high density of secondary coil sets 39 can be achieved in particular because no plated through-holes 24 are arranged within the modulation region 14.

For better clarity, a first part of the exemplary embodiment shown in FIG. 6 is shown in FIG. 6a. A second part is shown in FIG. 6b. As shown in FIGS. 6a and 6b, the encoder system 10 may include a third receiver line set 44c and a fourth receiver line set 44d in addition to the first receiver line set 44a and the second receiver line set 44b. In addition, the at least one secondary coil set 39 can have a fifth secondary coil 16a, a sixth secondary coil 18a, a seventh secondary coil 20a, and an eighth secondary coil 22a, preferably the fifth secondary coil 16a and the seventh secondary coil 20a being in contact with the third receiver line set 44c and the sixth secondary coil 18a and the eighth secondary coil 22a being in contact with the fourth receiver line set 44d. The first secondary coil 16 to the eighth secondary coil 22a preferably each have a secondary coil contour 34, which is designed in the sine-cosine difference form. In FIGS. 6 to 6b, this contour is shown as an oval for easier representation.

Preferably, the secondary coils in contact with the same receiver line set are arranged so as to be offset in the longitudinal direction 36 in different blocks. Thus, the first secondary coil 16 can be arranged in a first block 52 and the third secondary coil 20 can be arranged in a second block 54, the first secondary coil 16 and the third secondary coil 20 both being in contact with the first receiver line set 44a and being arranged so as to be offset in the longitudinal direction 36. Accordingly, the second secondary coil 18 can be arranged in the first block 52 and the fourth secondary coil 22 can be arranged in the second block 54, the first secondary coil 18 and the third secondary coil 20 both being in contact with the second receiver line set 44b and being arranged so as to be offset in the longitudinal direction 36. Correspondingly, the fifth secondary coil 16a can be arranged in the first block 52 and the seventh secondary coil 20a can be arranged in the second block 54, the fifth secondary coil 16a and the seventh secondary coil 20a both being in contact with the third receiver line set 44c and being arranged so as to be offset in the longitudinal direction 36. Accordingly, the sixth secondary coil 18a can be arranged in the first block 52 and the eighth secondary coil 22a can be arranged in the second block 54, the sixth secondary coil 18a and the eighth secondary coil 22a both being in contact with the fourth receiver line set 44d and being arranged so as to be offset in the longitudinal direction 36.

FIG. 6a shows the secondary coils 16, 18, 20, 22 in contact with the first receiver line set 44a and the second receiver line set 44b. FIG. 6b shows the secondary coils 16a, 18a, 20a, 22a in contact with the third receiver line set 44c and the fourth receiver line set 44d. In the illustrations in FIGS. 6 to 6b, the secondary coil conductor tracks 23 arranged in a first conductor support level are shown as solid lines. The secondary coil conductor tracks arranged in a second conductor support level are shown as dashed lines.

In FIG. 6, the two parts of the encoder system 10 shown in FIGS. 6a and 6b are shown in combination. In particular, it can be seen from this illustration that the adjacent secondary coils 16, 16a, 18, 18a and 20, 20a, 22, 22a can be arranged on different conductor support levels. There is preferably no offset between the adjacent secondary coils. In particular, the adjacent sections of the secondary coil conductor tracks 23 can lie on top of one another. For reasons of illustration and for better visibility, these sections are shown partially next to one another in FIG. 6.

The arrows partially arranged on the secondary coils in FIGS. 6 to 6a show, by way of example, the flow direction 56 of the current induced in the respective coil when no target 25 is arranged above it. If there is no target 25, the resulting currents in the receiver line sets 44a to 44d at least approximately cancel each other out. If the target 25 is at least partially arranged above one of the secondary coils 16 to 22a, a voltage can be measured on the respective receiver line set 44a to 44d.

If the encoder system 10 has a plurality of successive secondary coil assemblies 15, the target 25, as indicated in FIG. 6, is preferably designed in such a way that it has a plurality of target elements. The target elements are preferably arranged at such a distance from one another that the corresponding secondary coils 16, 16a, 18, 18a, 20, 20a, 22, 22a of two successive secondary coil assemblies 15 can be covered. The target 25 can therefore be designed as a grid. This allows the target to be arranged simultaneously over the corresponding secondary coils 16, 16a, 18, 18a, 20, 20a, 22, 22a.

The invention can be designed such that the first receiver line set 44a and the third receiver line set 44c are in electrically conductive contact with one another, and that the second receiver line set 44b and the fourth receiver line set 44d are in electrically conductive contact with one another. As a result, when using the encoder system 10, it may be sufficient to connect two of the receiver line sets 44a, 44b, 44c, 44d to an evaluation unit. Preferably, the first receiver line set 44a and the third receiver line set 44c as well as the second receiver line set 44b and the fourth receiver line set 44d are in contact with one another in such a way that the adjacent secondary coils 16, 16a, 18, 18a and 20, 20a, 22, 22a have different flow directions 56.

### LIST OF REFERENCE NUMERALS

10 Encoder system
12 Primary coil
12a First primary coil
12b Second primary coil
14 Modulation range
15 Secondary coil assembly
16 First secondary coil
16a Fifth secondary coil
18 Second secondary coil
18a Sixth secondary coil
20 Third secondary coil
20a Seventh secondary coil
22 Fourth secondary coil
22a Eighth secondary coil
23 Secondary coil conductor track
24 Plated through-hole
25 Target
28 Connection conductor track
30 Assembly contour
32 Secondary coil area
34 Secondary coil contour
36 Longitudinal direction
38 Insulating gap
39 Secondary coil set
40 Upward delimiting contour line
42 Receiver track
44a First receiver line set
44b Second receiver line set
44c Third receiver line set
44d Fourth receiver line set
46 Outer diameter
48 Inner diameter
50 Direction of current
52 First block
54 Second block
56 Flow direction
110 Encoder system
112 Primary coil
114 Modulation range
115 Secondary coil assembly
116 First secondary coil
118 Second secondary coil
120 Third secondary coil
122 Fourth secondary coil
123 Secondary coil conductor track
124 Plated through-hole
125 Target

1. A secondary coil assembly (15) for an inductive encoder system (10) comprising a plurality of secondary coils (16, 16a, 18, 18a, 20, 20a, 22, 22a), each secondary coil (16, 16a, 18, 18a, 20, 20a, 22, 22a) comprising a secondary coil conductor track (23), characterized in that the secondary coil conductor tracks (23) are arranged on a conductor support such that they do not cross.)

2. The secondary coil assembly according to claim 1, characterized in that each secondary coil (16, 16a, 18, 18a, 20, 20a, 22, 22a) has a secondary coil surface (32) with a secondary coil contour (34), the secondary coil contour (34) corresponding to the contour, which has a sine-cosine difference surface included in the interval of 45° to 225° between a sine function and a cosine function.

3. The secondary coil assembly according to claim 1, characterized in that the secondary coil assembly (15) has an assembly contour (30) which corresponds at least in sections to the contour which has a surface which is formed by a plurality of sine-cosine difference surfaces arranged adjacent to one another.

4. The secondary coil assembly according to claim 1, characterized in that the secondary coil assembly (15) is arranged linearly, circularly or annularly

5. The secondary coil assembly according to claim 1, characterized in that the secondary coils (16, 16a, 18, 18a, 20, 20a, 22, 22a) are arranged adjacent to one another in a longitudinal direction (36) of the secondary coil assembly (15).

6. The secondary coil assembly according to claim 5, characterized in that the secondary coils (16, 16a, 18, 18a, 20, 20a, 22, 22a) are arranged in a plurality of blocks (52, 54) arranged parallel to one another in the longitudinal direction (36).

7. The secondary coil assembly according to claim 1, characterized in that the conductor support has at least one conductor support level and the adjacent secondary coils (16, 16a, 18, 18a, 20, 20a, 22, 22a) are arranged in the same conductor support level, or in that the adjacent secondary coils (16, 16a, 18, 18a, 20, 20a, 22, 22a) are arranged on different conductor support levels.

8. An inductive encoder system (10) comprising at least one primary coil (12, 12a, 12b), which has a modulation region (14), and at least one receiver track (42), which has at least one receiver line set (44a, 44b, 44c, 44d) and a secondary coil assembly (15) according to claim 1, wherein the secondary coil assembly (15) is arranged within the modulation region (14).

9. The inductive encoder system according to claim 8, characterized in that the encoder system (10) has at least one secondary coil set (39) made up of a plurality of secondary coils (16, 16a, 18, 18a, 20, 20a, 22, 22a), wherein the secondary coils (16, 16a, 18, 18a, 20, 20a, 22, 22a) of the at least one secondary coil set (39) are in contact with the at least one receiver line set (44a, 44b, 44c, 44d) in such a way that the secondary coils (16, 16a, 18, 18a, 20, 20a, 22, 22a) in contact with the same receiver line set have different flow directions (56).

10. The inductive encoder system according to claim 9, characterized in that the at least one receiver track (42) has a first receiver line set (44a) and a second receiver line set (44b), and in that the at least one secondary coil set (39) has a first secondary coil (16), a second secondary coil (18), a third secondary coil (20), and a fourth secondary coil (22), wherein the first secondary coil (16) and the third secondary coil (20) are in contact with the first receiver line set (44a) and the second secondary coil (18) and the fourth secondary coil (22) are in contact with to the second receiver line set (44b).

11. Inductive encoder system according to claim 10, characterized in that the at least one receiver track has a third receiver line set (44c) and a fourth receiver line set (44d), and that the at least one secondary coil set (39) has a fifth secondary coil (16a), a sixth secondary coil (18a), a seventh secondary coil (20a) and an eighth secondary coil (22a), the fifth secondary coil (16a) and the seventh secondary coil (20a) being contacted to the third receiver line set (44c) and the sixth secondary coil (18a) and the eighth secondary coil (22a) are contacted to the fourth receiver line set (44d).

12. The inductive encoder system according to claim 9, comprising a secondary coil assembly according to claim 6, characterized in that the secondary coils (16, 16a, 18, 18a, 20, 20a, 22, 22a) in contact with the same receiver line set (44a, 44b, 44c, 44d) are arranged so as to be offset in the longitudinal direction (36) in different blocks (52, 54).

13. The inductive encoder system according to claim 9, characterized in that the inductive encoder system (10) has a first receiver track (42) and a second receiver track (42), the first receiver track (42) having a plurality of secondary coil sets (39) and the second receiver track (42) having exactly one secondary coil set (39).

14. The inductive encoder system according to claim 8, characterized in that the at least one primary coil (12, 12a, 12b) is arranged on a first conductor support level and the secondary coil assembly (15) is arranged on a second conductor support level.

15. The inductive encoder system according to claim 8, characterized in that the at least one primary coil (12, 12a, 12b) is annular.

16. The inductive encoder system according to claim 15, characterized in that the modulation region (14) is annular with an outer diameter (46) and an inner diameter (48), and is delimited on the outer diameter (46) by a first primary coil (12a) and on the inner diameter (48) by a second primary coil (12b).

17. The inductive encoder system according to claim 16, characterized in that a current direction (50) in the first primary coil (12a) is designed to be opposite to the current direction (50) in the second primary coil (12b).
